(19) United States
(12) Patent Application Publication
(10) Pub. No.: US 2002/0142274 A1
(43) Pub. Date: Oct. 3, 2002

(54) Human resources mixture skill development method and human resources mixture skill development planning apparatus

(75) Inventor: Akio Fujino, Ota (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/107,391

(22) Filed: Mar. 28, 2002

(30) Foreign Application Priority Data
Mar. 30, 2001 (JP) 2001-102602
Mar. 18, 2002 (JP) 2002-073926

(51) Int. Cl. G09B 19/00

(52) U.S. Cl. 434/219

(57) ABSTRACT

A human resources mixture skill development method suitable for being used by an entity comprises: a human resources mixture skill definition step that defines achievement in skill items of a human resources mixture required by the entity; a human resources mixture skill measurement step that measures achievement in the skill items of the current human resources mixture of the entity; and a first training path calculation step that generates training paths including combinations of a plurality of training courses so as to fill in differences between the achievement in the skill items defined in the human resources mixture definition step and the achievement in the skill items measured in the human resources mixture skill measurement step, and derives a training path that has the best value of numeric data, each of the numeric data being preassigned to each of the training courses, from a plurality of the training paths generated.

### BACKGROUND OF THE INVENTION

1. Field of the Invention

The present invention relates to a human resources mixture skill development method and a human resources mixture skill development planning apparatus.

2. Description of the Related Art

Conventionally, in an entity such as an enterprise or the like, a member of the entity enjoys a training service such as:

(1) when a person who is in charge of personnel affairs or the like prepares a broad training plan and orders the member of the entity to participate in training courses after a process of obtaining sanction for the plan by circulating a draft proposal; and

(2) when the member of the entity requests to participate in the training courses and applies for the training courses with an approval of the person or the like.

However, a view point such that training is for structuring a human resources mixture (a combination of people with a plurality of skills that are necessary for achieving objects of an organization) which the enterprise requires is lacking when a human resources department, a department concerned with training or the like orders the member to participate in the training courses as well as when the member of the entity requests and participates the training courses. Thus, even when a multitude of the training courses are held on a daily basis, there is no guarantee that the human resources mixture that is necessary for achieving business objectives of the entity is achieved.

Additionally, in general, the training plan is formed in consideration of upgrading the skills of each member according to the current skills of the member. Thus, it is physically impossible to recognize a required human resources mixture for the enterprise first so as to form an optimum training plan for the required human resources.

Further, when the member of the entity applies for the training courses and asks approval from a person who is in charge of personnel affairs or the like, it is difficult for the person to determine whether or not to approve participation in the training courses since the person does not have a tool for determining advisability of the participation in the training courses. In addition, in the case above, the person has a hard time giving a reasonable explanation for not approving the training courses to the member who applies for the training courses. For this reason, in many enterprises, it depends on individual choice as to what kind of education to receive in many cases. That is, in many cases, it is not specifically determined whether or not the training courses that the member applies for are effective for the enterprise, and the member participates in the training courses by obtaining formal approval from a supervisor.

However, the training in the enterprise forms a basis of corporate activity that matches the times and is an important matter. Thus, it is a matter of grave concern to leave it to the individual's free will to decide the training courses in the enterprise to participate in.

### SUMMARY OF THE INVENTION

It is a general object of the present invention to provide an improved and useful method of obtaining a training path for obtaining the required human resources mixture of an entity such as the enterprise or the like in which the above-mentioned problems are eliminated.

Another object of the present invention is to determine advisability of the training courses when the individual applies for the training courses by comparing the training courses for which the individual applies for with training courses included in the training path obtained by the above-mentioned method.

The object described above is achieved, according to one aspect of the present invention, by a human resources mixture skill development method suitable for being used by an entity, comprising: a human resources mixture skill definition step that defines achievement in skill items of a human resources mixture required by the entity; a human resources mixture skill measurement step that measures achievement in the skill items of the current human resources mixture of the entity; and a training path calculation step that generates training paths including combinations of a plurality of training courses so as to fill in differences between the achievement in the skill items defined in the human resources mixture definition step and the achievement in the skill items measured in the human resources mixture skill measurement step, and derives a first training path that has the best value of numeric data, each of the numeric data being preassigned to each of the training courses, from a plurality of the training paths generated.

Accordingly, it is possible to obtain the training path for obtaining the required human resources mixture required by the entity such as the enterprise.

The object described above is also achieved, according to another aspect of the present invention, by a human resources mixture skill development method to be carried out by the operation of a computer and suitable for being used by an entity, comprising: a human resources mixture skill definition step that defines achievement in skill items of a human resources mixture required by the entity; a human resources mixture skill measurement step that measures achievement in the skill items of the current human resources mixture of the entity; and a training path calculation step that generates training paths including combinations of a plurality of training courses so as to fill in differences between the achievement in the skill items defined in the human resources mixture definition step and the achievement in the skill items measured in the human resources mixture skill measurement step, and derives a training path that has the best value of numeric data, each of the numeric data being preassigned to each of the training courses, from a plurality of the training paths generated.

Therefore, it is possible to provide a software program for obtaining the required human resources mixture required by the entity such as the enterprise in a shorter time.

The object described above is also achieved, according to another aspect of the present invention, by a human resources mixture skill development planning apparatus, comprising: a client company human resources mixture table having information of skill items required by the entity and required achievement in the skill items; a current human resources skill table having information of achievement in the skill items of current personnel; a training course table having information of numeric data relating to the participation in training courses and to changes in achievement resulting from the participation in the training courses; a training path calculation part that generates training paths including combinations of a plurality of training courses that fill in differences between the achievement in the current human resources skill table and the required achievement of the skill items in the client company human resources mixture table, and selects a training path that has the best value of numeric data relating to the participation in the training courses included in all the training courses out of the training paths generated.

Thus, it is possible to provide the human resources mixture skill development planning apparatus in order to obtain the required human resources mixture required by the entity such as the enterprise.

According to the present invention, the entity such as the enterprise can set the best path for developing the human resources by the training in accordance with the business objectives.

Further, according to the present invention, when the individual applies for the training courses, it is possible to determine advisability of the participation in the training courses by comparing the training courses for which the member applies with the training courses included in the optimum path of human resources skill development that is set.

Other objects, features and advantages of the present invention will become more apparent from the following detailed description when read in conjunction with the following drawings.

### BRIEF DESCRIPTION OF THE DRAWINGS

FIG. 1 is a schematic diagram showing a system structure according to a first embodiment of the present invention;

FIG. 2 is a flow chart of an illustration of a process flow according to the first embodiment of the present invention;

FIG. 3 is a flow chart of an illustration of a process flow calculating an optimum human resources skill development combination using a genetic algorithm according to the first embodiment of the present invention;

FIG. 4 is a schematic diagram showing an illustration of a client company required human resources mixture table according to the first embodiment of the present invention;

FIG. 5 is a schematic diagram showing an illustration of a client company current skill table according to the first embodiment of the present invention;

FIG. 6 is a schematic diagram showing an illustration of a training course table according to the first embodiment of the present invention;

FIG. 7 is a schematic diagram showing an illustration of an individual training path table according to the first embodiment of the present invention;

FIG. 8 is a schematic diagram showing an illustration of an individual training path cost table according to the first embodiment of the present invention;

FIG. 9 is a schematic diagram showing an illustration of an optimum human resources mixture skill development plan according to the first embodiment of the present invention;

FIG. 10 is a schematic diagram showing an illustration of an initial state of an optimum human resources mixture skill development combination according to an embodiment of the present invention;

FIG. 11 is a schematic diagram showing an illustration of a midstream state of the optimum human resources mixture skill development combination according to the first embodiment of the present invention;

FIG. 12 is a schematic diagram showing a system structure according to a second embodiment of the present invention;

FIG. 13 is a flow chart of an illustration of a process flow (part 1) according to the second embodiment of the present invention;

FIG. 14 is another flow chart of an illustration of a process flow (part 2) according to the second embodiment of the present invention; and

FIG. 15 is a schematic diagram for explaining parts included by a server for providing an optimum human resources mixture skill development planning system.

### DETAILED DESCRIPTION OF THE PREFERRED EMBODIMENTS

(First Embodiment)

A first embodiment relates to determination of an optimum path for structuring a human resources mixture required by an enterprise, for example. The enterprise requires a plurality of various human resources in order to achieve business objectives. For example, an expert on accounting, an expert on law, an expert on business, an expert on management planning, and the like. The enterprise plans an ideal required human resources mixture in order to achieve the business objectives. However, in reality, the current human resources mixture does not necessarily match the ideal human resources mixture. On the contrary, reality is that the human resources mixture lacks some of the required skills. Accordingly, the enterprise develops the skills of the human resources so as to achieve the required human resources mixture.

Generally, the simplest method of developing the skills is training. Thus, the present invention is for obtaining the optimum path for structuring the ideal human resources mixture through training.

Additionally, in an optimum path calculation, computational time is decreased by using a genetic algorithm.

Next, a description will be given of the first embodiment of the present invention with reference to drawings.

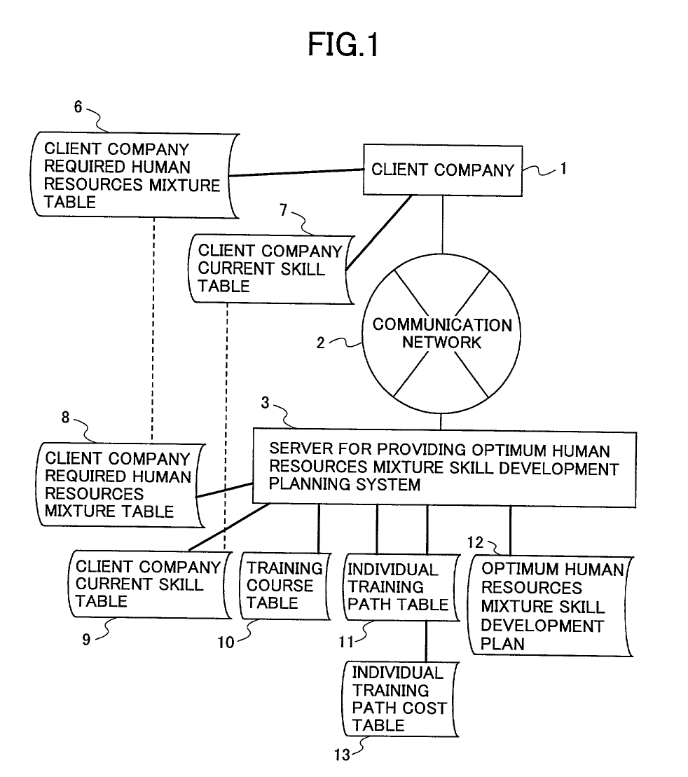

FIG. 1 shows an illustration of a system structure according to the first embodiment of the present invention. The system 1 in FIG. 1 includes a client company 1, a communication network 2, a server 3 for providing an optimum human resources mixture planning system (an apparatus for forming a human resources mixture development plan), client company required human resources mixture tables 6 and 8, client company current skill tables 7 and 9, a training course table 10, an individual training path table 11, an optimum human resources mixture skill development plan 12 and an individual training path cost table 13.

The client company 1 seeks the optimum training path for structuring the ideal human resources mixture. The client company 1 includes the client company required human resources mixture table 6 storing the human resources mixture required by the client company and the client company current skill table 7 storing the skills the current members of the client company have. Further, when the server 3 has the client company required human resources mixture table 8 and the client company current skill table 9, it is not always necessary for the client company 1 to have the client company required human resources mixture table 6 and the client company current skill table 7.

Similarly, when the client company 1 has the client company required human resources mixture table 8 and the client company current skill table 9, it is not necessary for the server 3 to have the client company required human resources mixture table 6 and the client company current skill table 7.

The communication network 2 is a network of communication such as Internet, mobile communication network and the like. The server 3 forms an optimum human resources mixture skill development plan for the client company based on a request from the client company.

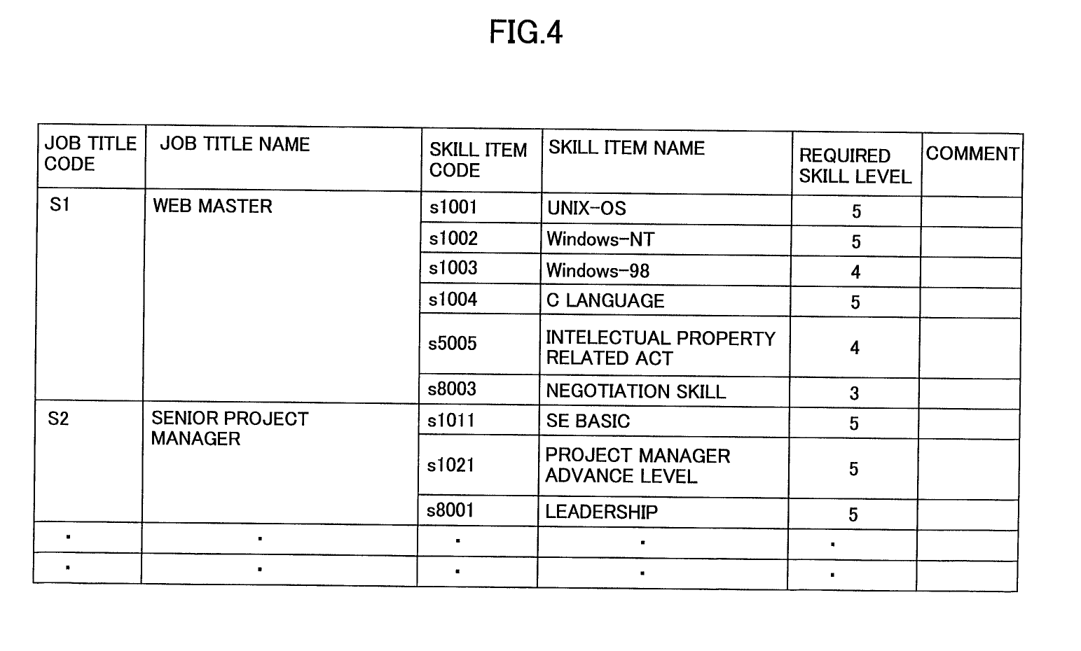

The client company required human resources mixture tables 6 and 8 store the required human resources mixture in accordance with a company strategy. FIG. 4 shows an illustration of the client company required human resources mixture table. In FIG. 4, the client company required human resources mixture table includes a job title name, a skill item code, a skill item name, a required skill level and the like. A job title code is a code for the job title name. In this case, it is assumed that n members, from S1 through Sn, of human resources are required. The job title name refers to a type of a roll that is required from the enterprise and includes a predetermined skill set. For example, a WEB master, a senior project manager, and the like. The skill item code refers to a code of a skill item. The skill item name refers to a skill item required for the job title name, such as UNIX-OS, Windows-NT and the like. The required skill level indicates a skill level of the skill item by 5 grades.

The client company current skill tables 7 and 9 store the skills of the current human resources of the client company.

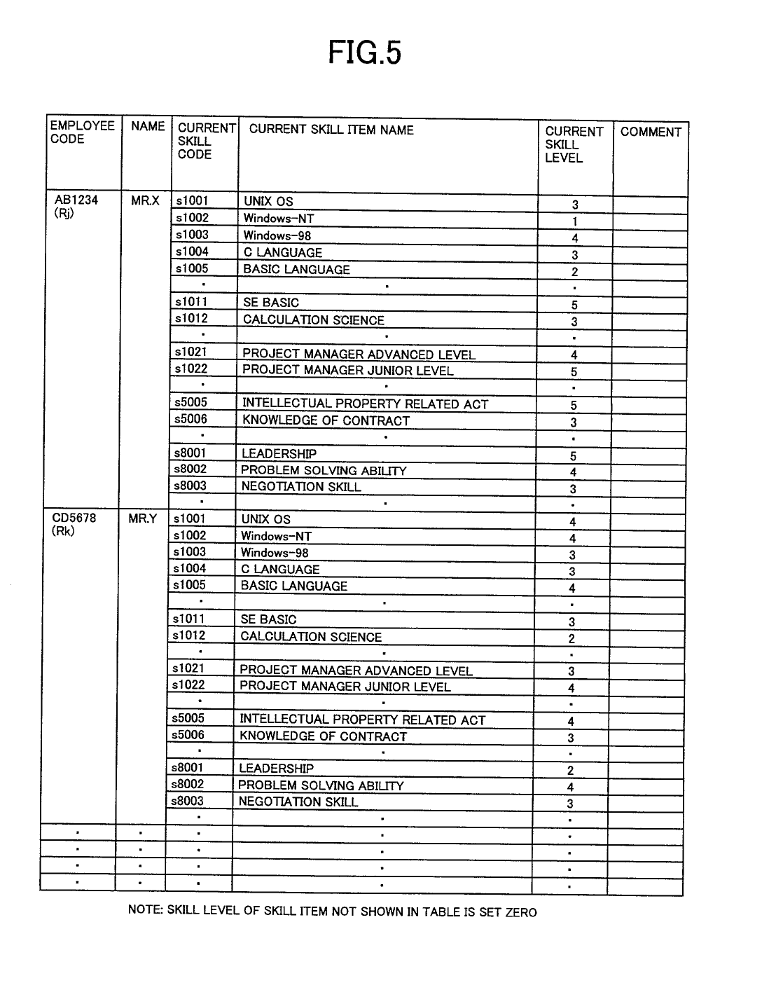

FIG. 5 shows an illustration of the client company current skill table 7. In FIG. 5, the client company current skill table 7 includes an employee code, a name, a current skill code, a current skill item name, a current skill level and the like. The employee code refers to a code of an employee, and the name refers to a name of an employee. The current skill code refers to a code of the current skill item name. The current skill level refers to a skill such as UNIX-OS, Windows-NT and the like. The current skill level indicates the skill level of the employee in five grades with regard to the current skill item.

In FIG. 5, the current skills of two employees that have the employee codes of AB1234 and CD5678, respectively, are shown. The current skills are shown with regard to the same number of human resources (n people) as the required human resources (n people) in total. It is assumed that when there are not as many as n employees, employees needed are employed in the future and handled as having no current skill. In FIG. 5, two out of n people, AB1234 and CD5678 are shown.

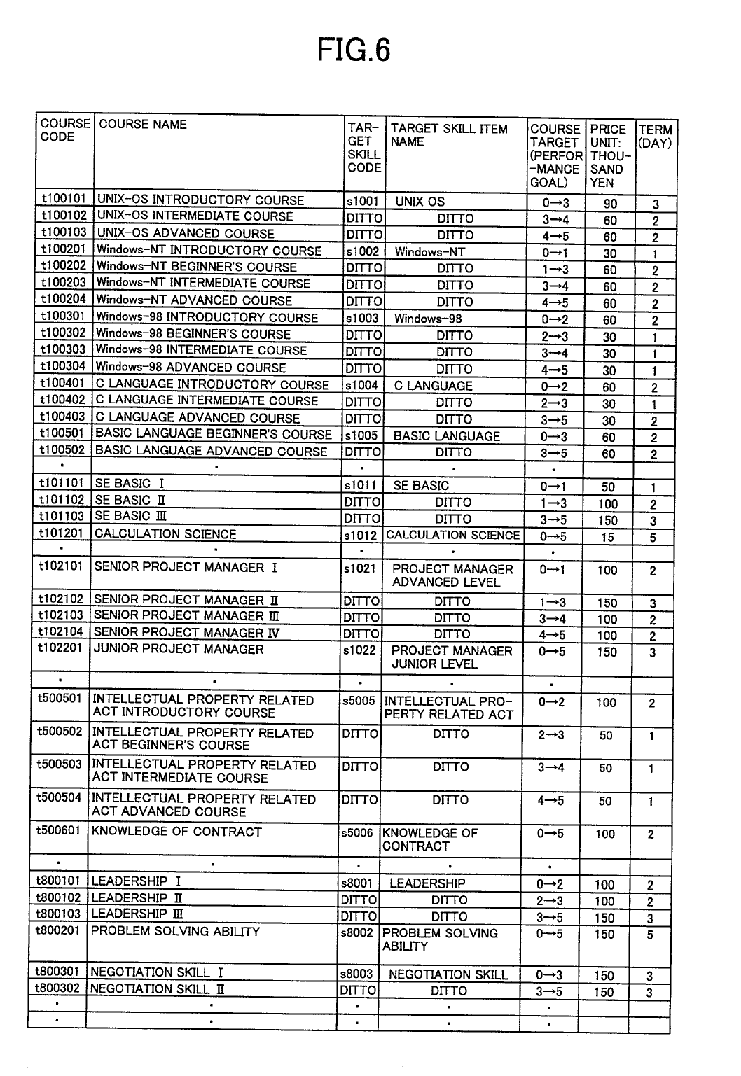

The training course table 10 stores training courses for the human resources development. FIG. 6 shows an illustration of the training course table 10. In FIG. 6, the training course table 10 includes a course code, a course name, a target skill code, a target skill item name, a course objective, a price and a term. The course code refers to a code of the training course, and the course name refers to a name of the training course such as an introductory course of UNIX-OS, an intermediate course of UNIX-OS and the like. The target skill code refers to a code of the target skill item name, and the target skill item name refers to the skill name upskilled in the training. The course objective indicates a degree of the level raised by the training comparing the level before the training and after the training. The price and the term refer to those required for the training.

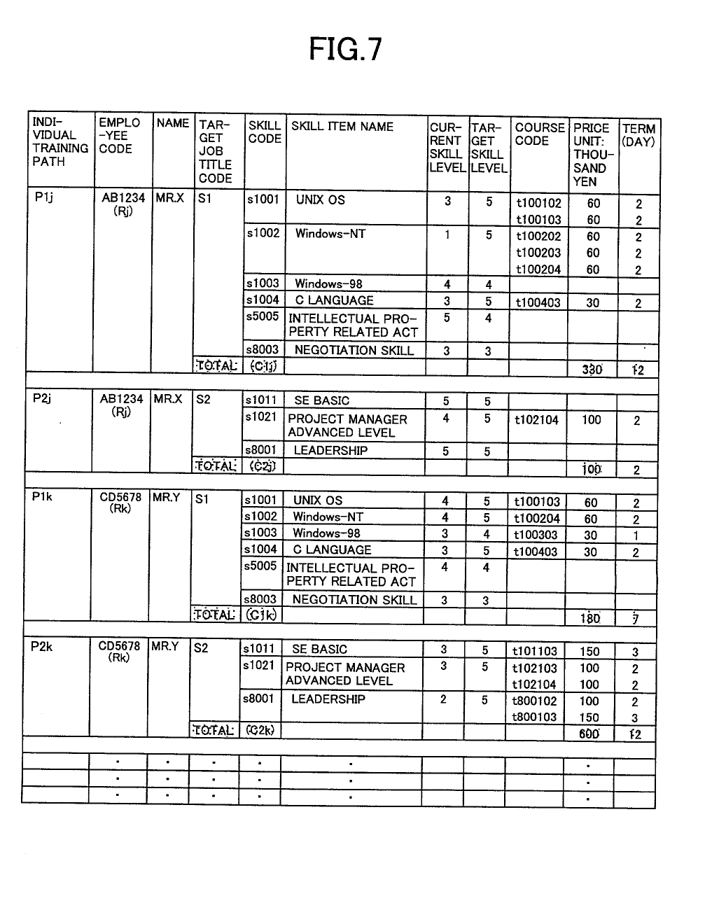

The individual training path table 11 stores all the training for each of the employees for upgrading of skills to be human resources the enterprise requires. FIG. 7 shows an illustration of the individual training path table. In FIG. 7, the individual training path table includes an individual training path, an employee code, a name, a target job title code, a skill code, a skill item name, a current skill level, a target skill level, a course code, a price and a term. The employee code, the name and the current skill level are the same as those corresponding items in FIG. 5. Additionally, the target job title code, the skill code, the skill item name, and the target skill level are the same as those corresponding items in FIG. 4. Further, the course code, the price and the term are the same as those corresponding items in FIG. 6.

According to FIG. 7, it is necessary for the current employee AB1234 (Rj) to acquire skills indicated by the skill codes “s1001”, “s1002”, “s1003”, “s1004”, “s5005” and “s8003” to have the skills of the required employee. There is no need to further participate in the training with regard to the skills indicated by the skill codes “s1003”, “s5005” and “s8003”, the skill item names of which are “Windows-98”, “intellectual property related act” and “negotiation skill”, respectively, since the current skill levels of the skills mentioned above have reached the target skill levels. However, it is necessary to further participate in the training with regard to the skills indicated by the skill codes “s1001”, “s1002” and “s1004”, the skill item names of which are “UNIX-OS”, “Windows-NT” and “C language”, respectively, since the current skill levels of the skills mentioned above have not reached the target skill levels. The course code, the price and the terms indicate the course code of the training required participating in, and the price and term required for the training, respectively. Further, at the bottoms of the price and term, totals (C1j) of the price and term required for the individual training path P1j are shown.

Similarly, the individual training path P2j for the employee AB1234 (Rj) to be the required employee S2, the individual training path P1k for the employee CD5678 (Rk) to be the required employee S1, and the individual training path P2k for the CD5678 (Rk) to be the required employee S2 are shown.

The individual training path cost table 13 stores the courses to be participated in and the cost required for the training for each individual training path.

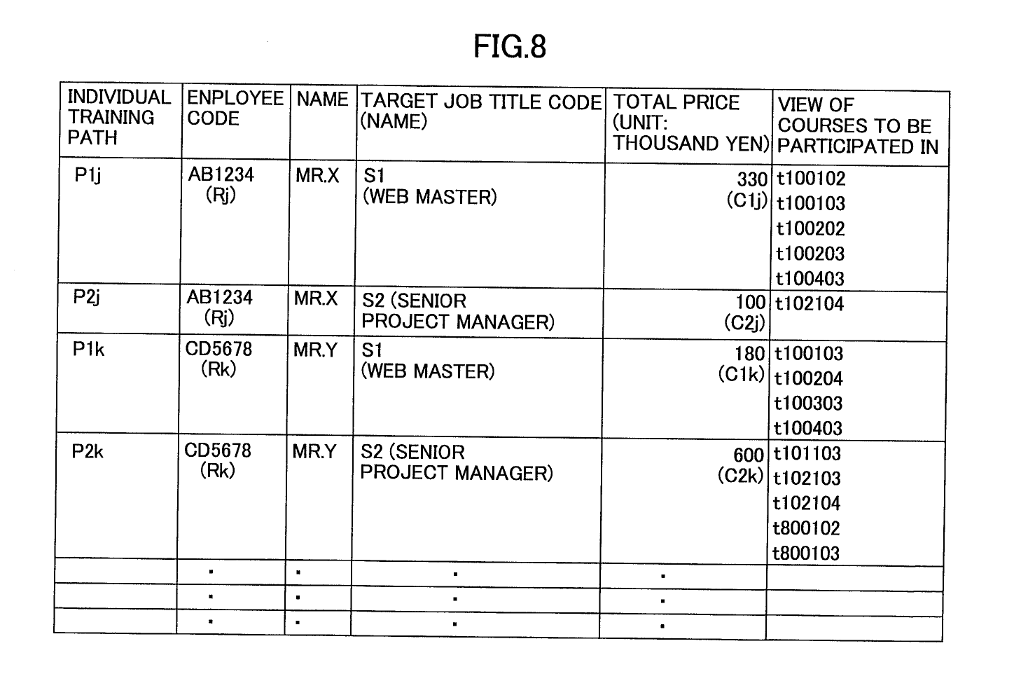

FIG. 8 shows an illustration of the individual training path cost table. The individual training path cost table includes an employee code, a name, a target job title code (name), a total price and a view of courses to be participated in. The employee code, the name and the target job title code (name) are the same as the employee code, the name and the target job title code in FIG. 7, respectively. The total price is the same as the total of the prices in FIG. 7 (C1j, C2j, C1k, C2k and the like). The courses in the view of courses to be participated in are the same as the course codes shown in FIG. 7.

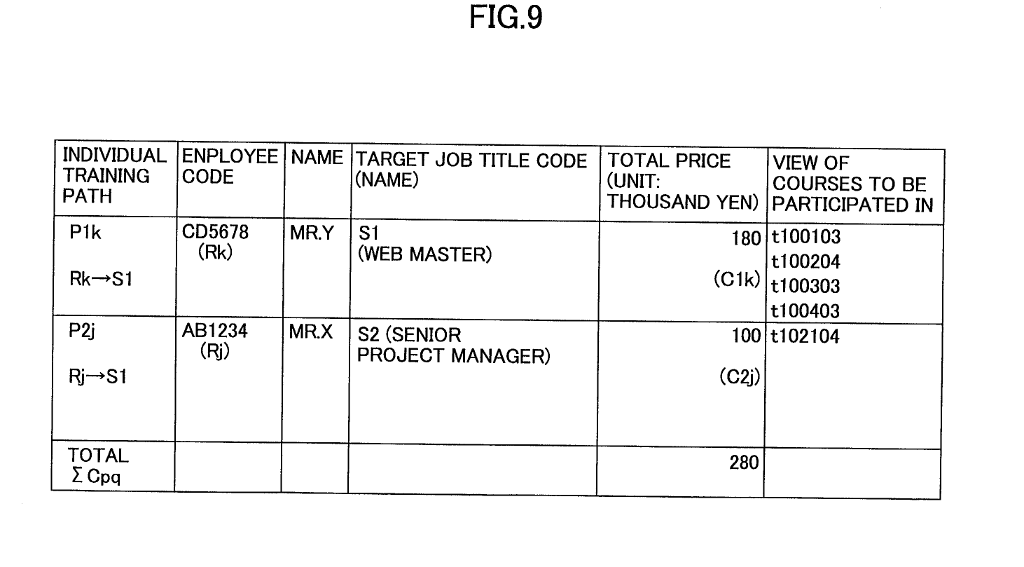

The optimum human resources mixture skill development plan 12 stores a final optimum human resources mixture skill development plan. FIG. 9 shows an illustration of the optimum human resources mixture skill development plan. The optimum human resources mixture skill development plan includes an employee code, a name, a target job title code (title), a total price and a view of courses to be participated in. The items in the optimum human resources mixture skill development plan are the same as those corresponding items in the individual training path cost table in FIG. 8. In a total field, ΣCpq obtained by a total of the prices is shown.

In FIG. 1, the client company is connected with the server 3 for providing an optimum human resources mixture planning system via the communication network 2. The client company has the client company required human resources mixture table 6 and the client company current skill table 7. The server 3 has the same tables (the client company required human resources mixture table 8 and the client company current skill table 9). These two tables may be created by either the client company 1 or the server 3. Additionally, the server 3 includes the training course table 10, and further generates intermediate tables temporarily such as the individual training path table 11, the individual training path cost table 13 and the like.

The server 3 finally forms the optimum human resources mixture skill development plan 12.

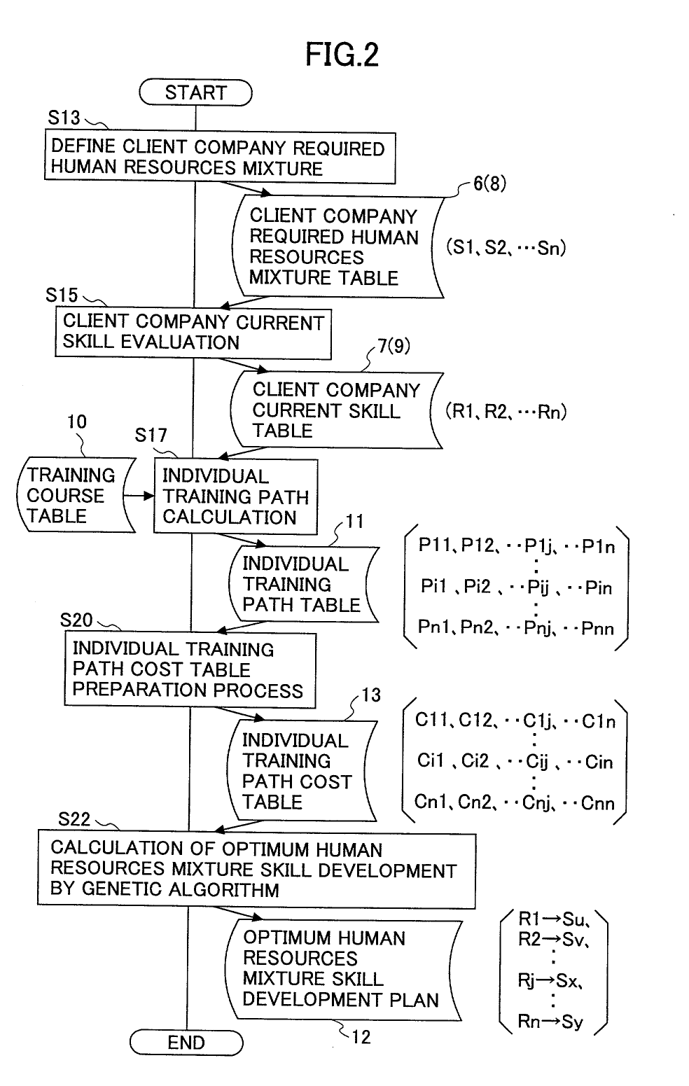

Referring to FIG. 2, a description will be given of a process flow of how the optimum human resources mixture skill development plan is formed.

First, the client company 1 defines the required human resources mixture (S1, S2, . . . Sn) (step S13) and stores the required human resources mixtures in the client company required human resources mixture table 6 (8). It should be noted that Si is a vector value of a required skill. Assuming that m stands for a total of the various skills required by the company, Si is a vector of m dimensions. At the same time, either the client company 1 or the server 3 evaluates the current skill (step S15) and stores the evaluated current skill in the client company current skill table 7 (9). Further, in this case, when the number of current employees is less than n, the shortfall of the employees is made up by new hiring and the skills of those employees are set to zero since the skills cannot be evaluated at this moment. As a result, an actual human resources mixture (R1, R2, . . . Rn) is obtained and the actual human resources mixture obtained is stored in the client company current skill table 7. Additionally, the current skills are measured by setting an examination individually, or by using the method described in a Japanese Laid-Open Patent Application No. 08-077246 “Method for Generating Skill Command Setting Table and Growth Degree Deciding Method of Talented Person Cultivation Support System”.

Next, the training path is obtained. For each current employee, all the training required to be the ideal human resource is obtained. That is, the training path (P1j, P2j, . . . Pnj) for the jth current human resource Rj to reach the ideal human resources S1, S2, . . . Sn is obtained by referring to the training course table 10, and the training path obtained is stored in the individual training path table 11. This above-mentioned process is performed for all current employees (n people). As a consequence, a table with n records×n fields is generated as the individual training path table 11.

Next, the cost, for example, is calculated for each training path as an optimization index (in the following, the optimization index is referred to as the cost for the sake of convenience, however, other indexes, the term or the like may be possible)(step S20). The cost may be calculated simply by adding up the prices of the training courses on the training path, or by adding a salary of total training days to the total price of the training since the employee does not work during the training.

Taking notice of the jth current human resource Rj, the cost is a gathering of scalar quantities C1j, C2j, . . . Cnj. N×n matrix Cij can be obtained by calculating the scalar quantity for each current human resource from R1 through Rn. Thus obtained cost is stored in the individual training path cost table 13.

In the optimum human resources mixture skill development plan taking notice of the cost, a combination of Pij is determined so that the ΣCpq shown in FIG. 9 become the minimum value. This is completely a matter of permutation. That is, a matter of arranging n pieces in order without iteration and a performance function thereof is ΣCpq. The number of times of calculation is an order of n factorial when calculated simply by a round-robin method. Thus, when the n becomes large on some level, the calculation may be impossible.

Thus, an optimum path is obtained by using various optimizing calculation techniques so as to decrease the number of times of the calculation. In the present invention, a formulation by the genetic algorithm (GA) is proposed as an example of the optimizing calculation technique.

The optimum human resources mixture skill development combination calculation (step S22) using the genetic algorithm (GA) is performed as follows. First, ΣCpq is assumed to be an adaptive function. An initial condition of the optimum human resources mixture skill development combination is set by using random numbers. Consequently, n pairs of paths are prepared that do not allow the iteration with regard to the employee having the current skill Rj to become Se such as R1→Sa, R2→Sb, . . . Rj→Se, . . . Rn→Sg. Then, the adaptive function ΣCpq is calculated. Subsequently, according to the genetic algorithm, a combination calculations is repeated until the adaptive function ΣCpq becomes the minimum value by mutation, crossover and the like. When a convergence condition is fulfilled, the process ends. The minimum combination of the adaptive function ΣCpq, that is, R1→Su, R2→Sv, . . . Rj→Sx, . . . Rn→Sy is stored in the optimum human resources mixture skill development plan database 12 as the optimum human resources mixture skill development plan.

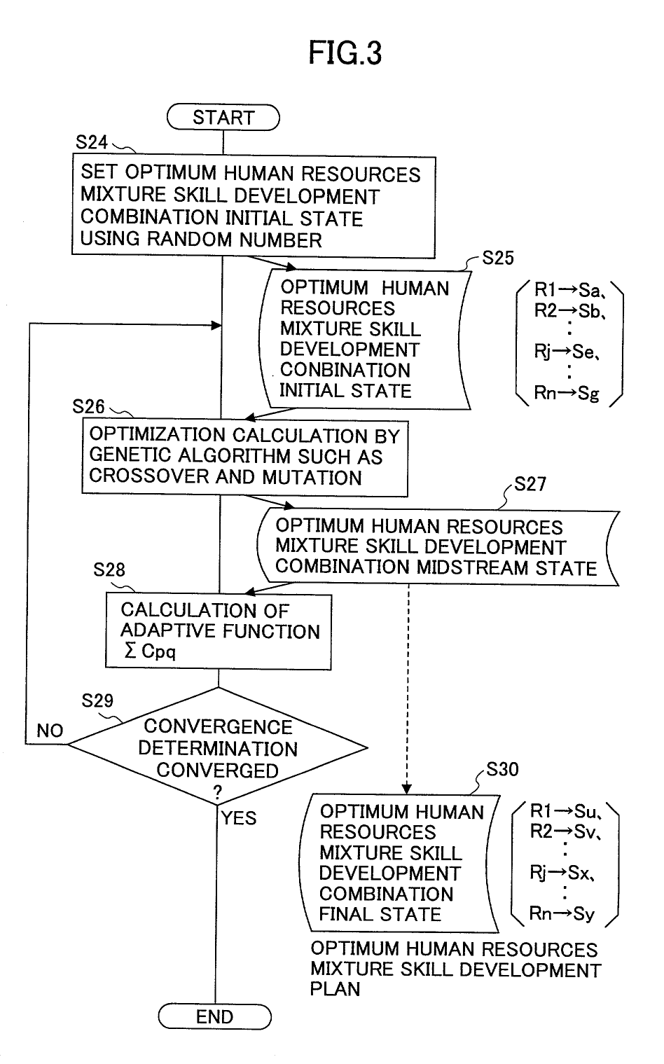

Next, FIG. 3 shows process steps of calculating the optimum training path using the genetic algorithm. First, by the optimum human resources mixture skill development combination initial condition setting process (step S24), the initial condition of the optimum human resources mixture skill development combination is set (step S25). Starting with this optimum human resources mixture skill development combination initial condition, the optimization calculation by the genetic algorithm such as the crossover, mutation and the like (step S26) is performed so as to assume an optimum human resources mixture skill development midstream state (step S27). Further, a calculation of the adaptive function ΣCpq is performed (step S28) and a convergence determination (whether converged or not) is carried out (step S29). When not converged (NO in step S29), the process returns to the optimization calculation by the genetic algorithm such as the mutation and the like (step S26). The process from the step S26 through the step S29 is repeated until a result of the convergence test becomes “converged”. When the result of the convergence test becomes “converged” (YES in step S29), the final optimum human resources mixture skill development combination midstream state is considered to be an optimum human resources mixture skill development combination final state (step S30).

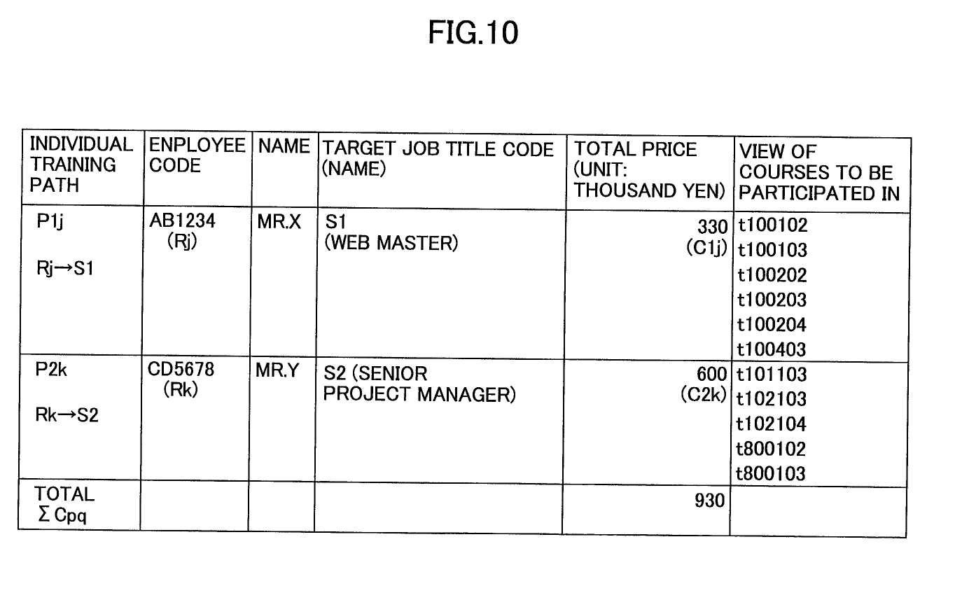

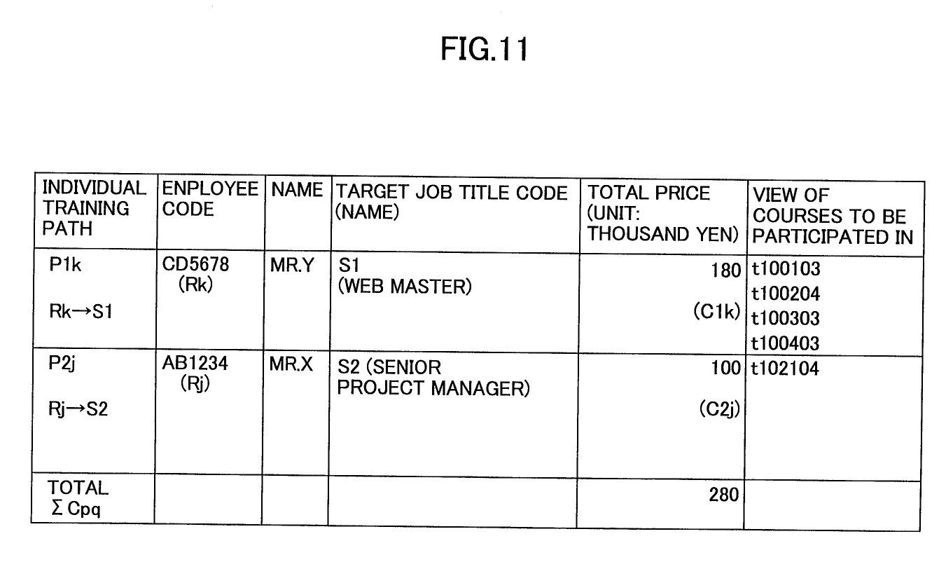

FIG. 10 shows the optimum human resources mixture combination initial state. In this case, it is assumed that only two combinations (P1j, P2k) and (P1k, P2j) are possible. In this example, the initial state according to the random numbers is (P1j, P2k) as shown in FIG. 10. Hereupon, a total cost of the training to be participated in, which is the adaptive function, is 930 thousand yen. Next, a combination shown in FIG. 11 (P1k, P2j) is obtained by the genetic algorithm such as the crossover (FIG. 11 shows the optimum human resources mixture skill development combination midstream state). In this case, the total cost is 280 thousand yen. Since this example has only two cases, the optimization calculation ends here, the minimum cost results in 280 thousand yen (p1k, P2j), and thus the optimum human resources mixture skill development plan is obtained. In a case where the n is a large number, when the result of the convergence test converged in approximately one solution in the optimization calculation process, the result of the convergence test is determined as “converged”, and the human resources mixture development combination thereof is considered to be the optimum human resources mixture skill development combination.

As described above, the first embodiment relates to the optimization of the human resources skill development plan in the enterprise, for example. The enterprise defines the skills of human resources required by the enterprise and forms the training plan for achieving the required skill. However, it is difficult to determine the optimum (for example, the minimum cost) training courses for a plurality of employees so as to reach the wide-ranging required skills. Accordingly, the present invention is for setting the optimum training totally by evaluating the skills of each employee in consideration of the required skills to reach the predetermined skills of the human resource required by the enterprise for each employee.

Further, the first embodiment can be used for purchasing a WBT (Web Based Training) education service and application for training courses. Additionally, the server 3 may not always be a server but an independent apparatus for the optimum human resources mixture skill development planning. The human resources mixture skill development planning apparatus of the present invention is a concept including the server for providing an optimum human resources mixture skill development planning system and the independent apparatus for the optimum human resources mixture skill development planning.

According to the first embodiment, it is possible to derive the optimum (the minimum cost, the shortest term, or the like) human resources development pattern in order to fill in the difference between the optimum human resources mixture required by the enterprise and the actual human resources mixture by using a means of recognizing the current human resources mixture and patterns of participating in the training courses for the human resources development.

Further, in the first embodiment, a means may be contrived in obtaining the optimum training path such that possible combinations are limited by adding a preference of the employee, a qualitative element, a policy of the enterprise and the like so as to decrease the amount of calculation.

According to the first embodiment of the present invention, by using the genetic algorithm (GA) for the optimization technique, an impossibility of calculation is avoided when the number of human resources n is large. Thus, the optimum human resources mixture skill development plan can be formed even in a large organization.

(Second Embodiment)

According to a second embodiment, it is possible to determine advisability of participating in the training courses by comparing the training courses that the member applies for with the training courses included in the optimum path of the human resources skill development plan obtained in the first embodiment when an individual that is a member of the entity applies for the training.

That is, information specifying the individual who applies for the training and information specifying the training courses that are applied for are received, and it is determined whether or not the training courses are included in the optimum path of the human resources skill development plan obtained in the first embodiment. When the training courses are included in the optimum path of the human resources skill development plan, the participation in the training courses is approved, and when the training courses are not included in the optimum path of the human resources skill development plan, the participation in the training courses is not approved.

Additionally, even when the participation in the training courses is not approved, in a case such that the member is eager for the training courses and the supervisor desires the member to participate in the training courses, another optimum path of the human resources skill development plan in the first embodiment is obtained again by specifying the member and the training courses that the member is eager for (a modified optimum human resources mixture skill development plan). Then, when the value of the numeric data almost matches the value before recalculation (modification), the training path obtained by the recalculation is regarded as the optimum path, and the participation in the training courses once not approved is approved.

Next, a description will be given of the second embodiment of the present invention with reference to drawings.

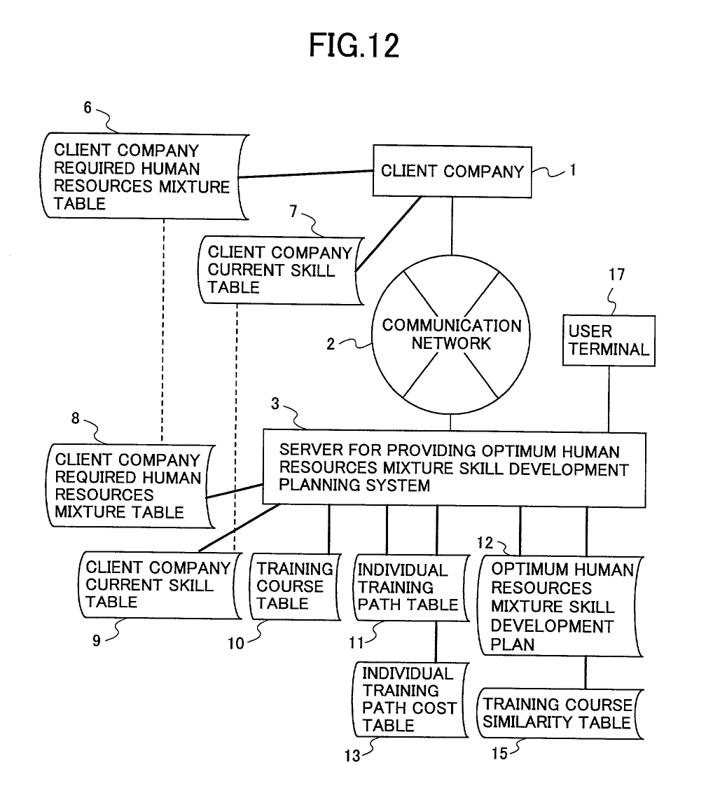

FIG. 12 shows an illustration of a system structure according to the second embodiment of the present invention. The system in FIG. 12 includes a client company 1, a communication network 2, a server 3 for providing an optimum human resources mixture skill development planning system (an apparatus for forming a human resources mixture skill development plan), client company required human resources mixture tables 6 and 8, client company current skill tables 7 and 9, a training course table 10, an individual training path table 11, an optimum human resources mixture skill development plan 12, an individual training path cost table 13, a training course similarity table 15 and a user terminal 17.

The training course similarity table 15 shows similarity among the training courses stored in the training course table 10. Additionally, the user terminal 17 is connected with the server 3. It is possible to use the optimum human resources mixture skill development planning system by using the user terminal 17. For example, a person who wants to apply for the training courses can apply for the training courses by using the user terminal 17. Further, the user terminal 17 may be connected with the network 2.

In FIG. 12, those parts other than the training course similarity table 15 and the user terminal 17 are the same as those corresponding parts in FIG. 1. Thus, an explanation thereof will be omitted.

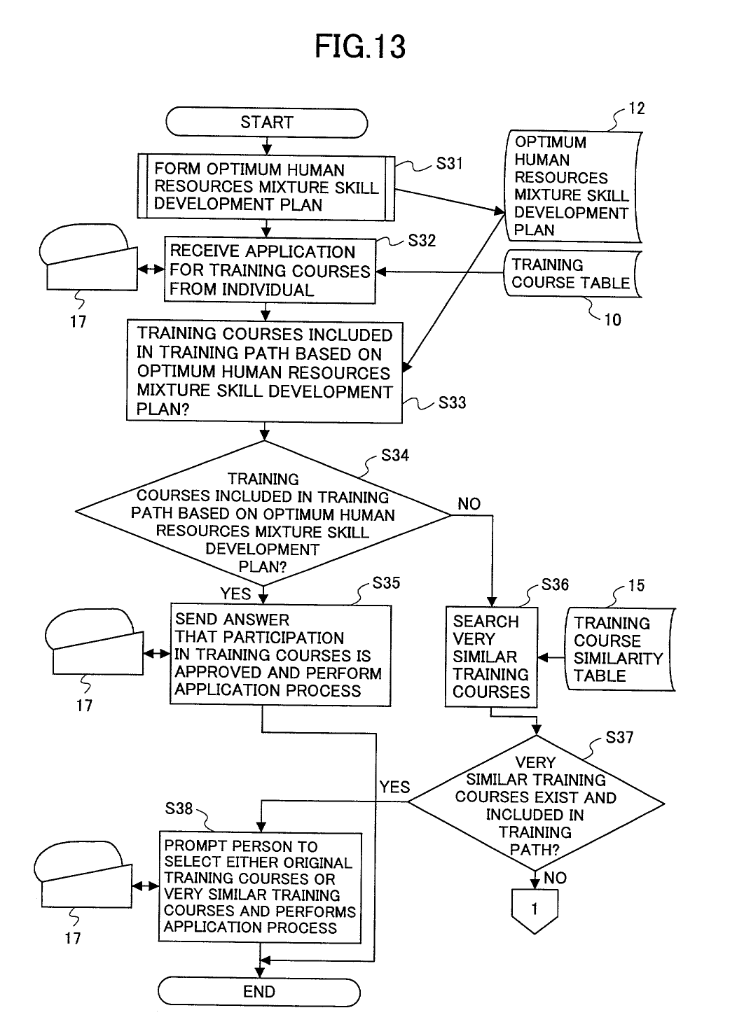

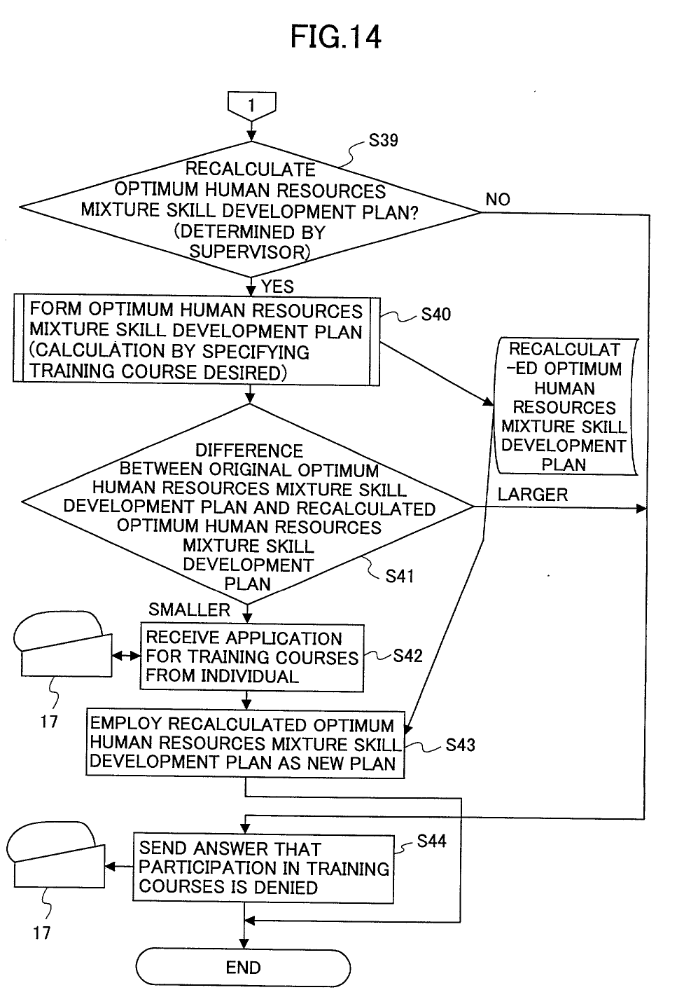

A description will be given of a process flow in the second embodiment with reference to FIGS. 13 and 14. First, as shown in FIG. 13, the optimum human resources mixture skill development plan 12 is formed based on the first embodiment (S31). In a state thereof, the person who wants to participate in the training courses applies for the training courses by the user terminal 17 referring to the training course table 10. The server 3 receives an application for the training courses (S32).

The server 3 determines whether or not the training courses are included in the training path based on the optimum human resources mixture skill development plan 12 (S33 and S34). When the training courses are included in the training path based on the optimum human resources mixture skill development plan 12 (YES in S34), the server 3 sends the user terminal 17 an answer that the participation in the training courses is approved. The user terminal 17 displays the answer on a display of the user terminal 17. Additionally, the server 3 performs an application process (S35).

Further, when the training courses are not included in the training path of the optimum human resources mixture skill development plan 12 (NO in S34), the server 3 searches the training course similarity table 15 so as to find training courses that are very similar to the training courses for which the person applies (S36). When the training courses that are very similar to the training for which the person applies exist as a search result and the training courses are included in the training path based on the optimum human resources mixture skill development plan 12 (YES in S37), the server 3 causes the user terminal 17 to display a window that prompts the person to select either the training for which the person applies or the training that is very similar to the training for which the person applies. When the person has made a selection of the course, the server 3 sends an answer to the user terminal 17 that the participation in the training courses is approved. The user terminal 17 displays the answer on the display. Additionally, the server 3 performs the application process (S38).

Further, in a case where the training courses are not included in the training path based on the optimum human resources mixture skill development plan 12 (NO in S34) and a condition that “the training courses that are very similar to the training courses for which the person applies exist, and the training courses are included in the training path based on the optimum human resources mixture skill development plan 12” is not fulfilled (NO in S37), the process shown in FIG. 14 is performed.

In addition, in step S37, ‘a condition that “the training courses that are very similar to the training courses for which the person applies exist, and the training courses are included in the training path based on the optimum human resources mixture skill development plan 12” is not fulfilled’ represents two cases. That is, where the training courses that are very similar to the training courses for which the person applies do not exist, and where the training courses that are very similar to the training courses for which the person applies exist, however, the training courses are not included in the training path based on the optimum human resources mixture skill development plan 12.

Next, referring to FIG. 14, a description will be given of the following process. In FIG. 13, in a case where the training courses for which the person applies are not included in the training path based on the optimum human resources mixture skill development plan 12 (NO in S34), and where a condition that “the training courses that are very similar to the training courses for which the person applies exist, and the training courses are included in the training path based on the optimum human resources mixture skill development plan 12” is not fulfilled (NO in S37), whether or not to recalculate the optimum human resources mixture skill development plan is determined (S39).

The determination is performed by the supervisor. The supervisor comprehensively determines an eagerness of the person for participation in the training courses, influence on the business by the participation in the training courses, necessity of the training, effectiveness of the training and the like. As a result, when the supervisor determines that the training is not necessary for the person (NO in S39), recalculation of the optimum human resources mixture skill development plan is not performed and an answer that the participation in the training is rejected is sent to the user terminal 17 by which the person applies for the training courses (S44).

Additionally, when the supervisor determines that the training is necessary (YES in S39), recalculation of the optimum human resources mixture skill development plan is performed by specifying the person who applies for the training courses and the training courses for which the member applies (S40). Then, cost and a term of the optimum human resources mixture skill development plan obtained by the recalculation are compared with the cost and term of the optimum human resources mixture skill development plan before the recalculation (S41). As a result, when a difference between the cost or term before the recalculation and the cost or term after the recalculation is larger than a permissible range (LARGER in S41), the server 3 sends an answer to the user terminal 17 that the participation in the training is rejected. The user terminal 17 displays the answer on the display (S44).

Additionally, as a result of the comparison, when the difference is equal to or smaller than the permissible range (SMALLER in S41), the server 3 sends an answer that the participation in the training is approved, and the user terminal 17 displays the answer on the display (S42). The server 3 employs the recalculated optimum human resources mixture skill development plan as a new optimum human resources mixture skill development plan (S43).

Further, the determination whether or not the cost or term after the recalculation is equal to or smaller than the permissible range is performed based on a predetermined reference value (for example, values such as xx yen and yy time, or a ratio such as z % of total cost or time).

Additionally, a method mentioned in a Japanese Patent Application No. 2000-263470 can be used for the determination of the similarity of the training courses in step S36.

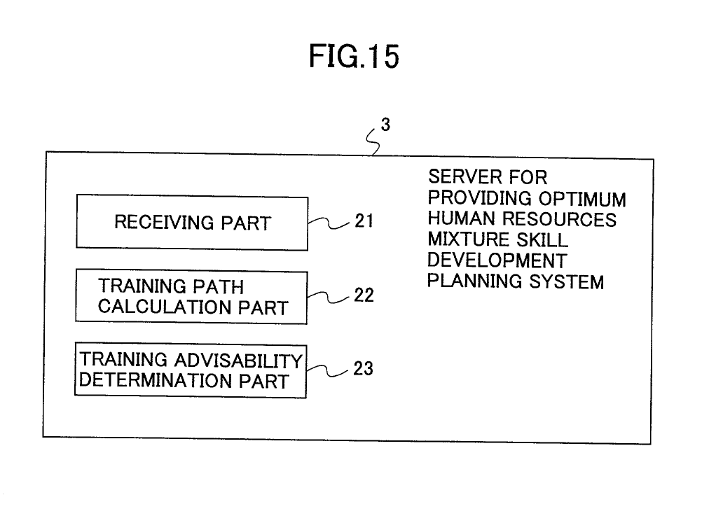

Further, the server 3 may have a program that causes a computer to perform processes shown in FIGS. 2, 3, 13 and 14. The server 3 may include various parts as shown in FIG. 15.

The server 3 shown in FIG. 15 includes three parts: a receiving part 21 that receives information specifying the member and information specifying the training for which the member applies when the member of the entity applies for the training; a training path calculation part 22 that generates a training path including combinations of a plurality of training courses so as to fill in the differences between the achievement in the skill items of the client company current skill tables 9 (7) and the achievement in the skill items of the client company required human resources mixture table 8 (6) having the skill items required by the entity and the achievement required for the skill items, and derives a training path 12 that has the best value of numeric data relating to the participation in the training courses included in all the training courses in the plurality of the training paths generated; a training advisability determining part 23 that determines advisability of the participation in the training courses of the member who applies for the training courses by comparing the training course that are received by the training receiving part 21 and the training course included in the best training path 12 derived by the training path calculation part 22.

The present invention is not limited to the specifically disclosed embodiments, and variations and modifications may be made without departing from the scope of the present invention.

The present application is based on Japanese priority applications No. 2001-102602 filed on Mar. 30, 2001, and No. 2002-73926 filed on Mar. 18, 2002, the entire contents of which are hereby incorporated by reference.

What is claimed is:

1. A human resources mixture skill development method suitable for being used by an entity, comprising:
a human resources mixture skill definition step that defines achievement in skill items of a human resources mixture required by the entity;
a human resources mixture skill measurement step that measures achievement in the skill items of the current human resources mixture of the entity; and
a training path calculation step that generates training paths including combinations of a plurality of training courses so as to fill in differences between the achievement in the skill items defined in the human resources mixture definition step and the achievement in the skill items measured in the human resources mixture skill measurement step, and derives a first training path that has the best value of numeric data, each of the numeric data being preassigned to each of the training courses, from a plurality of the training paths generated.

2. The human resources mixture skill development method as claimed in clam 1, wherein:
the numeric data comprises data relating to cost required for the training courses or to time required for the training courses.

3. The human resources mixture skill development method as claimed in claim 1, comprising:
a receiving step that receives information specifying a member of the entity and information specifying training courses that the member applies for; and
a training advisability determining step that determines advisability of participation in the training of the member by comparing the training courses received in the receiving step with the training courses included in the first training path derived in the training path calculation step.

4. The human resources mixture skill development method as claimed in claim 1, wherein:
the training path calculation step derives a second training path that has the best value of numeric data by fixing a specific member of the entity and specific training courses that the specific member should participate in.

5. The human resources mixture skill development method as claimed in claim 4, wherein:
when the value of numeric data of the second training path almost matches the value of numeric data of the first training path, the second training path is regarded as the best path.

6. A human resources mixture skill development method to be carried out by the operation of a computer and suitable for being used by an entity, comprising:
a human resources mixture skill definition step that defines achievement in skill items of a human resources mixture required by the entity;
a human resources mixture skill measurement step that measures achievement in the skill items of the current human resources mixture of the entity; and
a training path calculation step that generates training paths including combinations of a plurality of training courses so as to fill in differences between the achievement in the skill items defined in the human resources mixture definition step and the achievement in the skill items measured in the human resources mixture skill measurement step, and derives a training path that has the best value of numeric data, each of the numeric data being preassigned to each of the training courses, from a plurality of the training paths generated.

7. A human resources mixture skill development method as claimed in claim 6, further comprising:
a receiving step that receives information specifying a member of the entity and information specifying the training courses that the member applies for; and
a training advisability determining step that determines advisability of the participation in the training of the member by comparing the training courses received in the receiving step with the training courses included in the best training path derived in the training path calculation step.

8. A human resources mixture skill development planning apparatus, comprising:
a client company required human resources mixture table having information of skill items required by an entity and required achievement in the skill items;
a client company current skill table having information of achievement in the skill items of current personnel;
a training course table having information of numeric data relating to participation in training courses and to changes in achievement resulting from the participation in the training courses; and
a training path calculation part that generates training paths including combinations of a plurality of training courses so as to fill in differences between the achievement in the client company current skill table and the required achievement in the skill items in the client company required human resources mixture table, and selects a training path that has the best value of numeric data relating to the participation in the training courses included in all the training courses out of the training paths generated.

9. The human resources mixture skill development planning apparatus as claimed in claim 8, further comprising:
a receiving part that receives information specifying the member of the entity and information specifying the training courses that the member applies for; and
a training advisability determining part that determines advisability of the participation in the training of the member by comparing the training courses received in the receiving part with the training courses included in the best training path derived in the training path calculation part.
